(19) United States
(12) Patent Application Publication
(10) Pub. No.: US 2021/0137132 A1
(43) Pub. Date: May 13, 2021

(54) ROYAL ICING PREMIX COMPOSITION

(71) Applicant: Jacqueline Helen Curtis, Williamsburg, VA (US)

(72) Inventor: Jacqueline Helen Curtis, Williamsburg, VA (US)

(21) Appl. No.: 16/949,701

(22) Filed: Nov. 11, 2020

Related U.S. Application Data
(60) Provisional application No. 62/933,761, filed on Nov. 11, 2019.

(51) Int. Cl. A23G 3/34; A23G 3/44; A23G 3/42; A23L 29/25

(52) U.S. Cl. CPC A23G 3/343; A23G 3/44; A23V 2002/00; A23L 29/25; A23G 3/42

(57) ABSTRACT

An icing premix composition includes albumin, gum arabic, and confectionery sugar. The icing premix composition does not include meringue, citric acid, and titanium dioxide. The icing premix composition includes food starch in some cases. The icing premix composition produces a royal icing that is strong, flexible, and stretchy.

### CROSS-REFERENCE TO RELATED APPLICATION

This application claims the benefit of priority of U.S. provisional application No. 62/933,761, filed Nov. 11, 2019, the contents of which are herein incorporated by reference.

### BACKGROUND OF THE INVENTION

The present invention relates to royal icing and, more particularly, to a premix composition therefor.

Several problems exist with royal icing products used in the baking industry. Most commercially available royal icing products are too brittle and break easily, requiring repair. Existing royal icing products are insufficiently strong, flexible, and stretchy to allow an artist to achieve complex works. Moreover, commercially available royal icings contain meringue, citric acid, and/or titanium dioxide as a white pigment, each of which is prohibited as an icing ingredient in some foreign countries, such as France, and domestically, such as parts of California and Maryland under the Cottage Food laws. Existing products do not allow for various quantities to be used in each application. Commercially available royal icing products are provided as a wet end product, resulting in more user waste if the entire volume is not used in one application because the remaining amount cannot be easily resealed and stored. In addition, the large standard batch sizes may be cost prohibitive to small bakeries or home bakers wishing to use smaller quantities. Further, the existing royal icings including ingredients that users can readily purchase on their own less expensively.

As can be seen, there is a need for an inexpensive product that produces royal icing that is strong, flexible, and stretchy, and can be used in any desired amount without resulting in wasted icing.

The present invention is an icing premix comprising a combination of powdered ingredients. The premix produces a royal icing product that is surprisingly stronger, is more flexible, and exhibits more stretch than existing royal icing products, allowing the user more control and versatility when applying it to baked goods. The invention also produces an end product that is surprisingly less brittle so it does not break as easily as existing royal icings. It is less costly than a ready-to-use product and does not include ingredients that are widely available to users at a lower price.

The inventive composition is a dry product, i.e. not fully prepared as a wet end-product, which may be mixed in various quantities or volumes, reducing waste. It minimizes waste because smaller amounts may be used to create the end product, while the remaining premix may be resealed for future use. The invention has a longer shelf life after opening than existing products and takes up less shelf space for the same amount of royal icing produced.

The premix composition contains only the base ingredients needed to make the icing. The product uses different ingredients than any other product. In addition, the invention is less expensive for users because it includes only the essential ingredients used in the process of making royal icing. The invention advantageously allows the chef or artist to use the confectionery sugar of their choice.

This product has been tested by three leading international cake artists and a cake decorating instructor, who now endorse the product. It has enabled Food Network® competitors to win 5 competitions. The inventive premix is considered more “forgiving” than commercially available royal icings, so it can be used more easily on desserts. The premix can be successfully used in all climates, regardless of temperature and humidity. The premix is packaged in a resealable moisture barrier bag for added shelf stability.

### SUMMARY OF THE INVENTION

In one aspect of the present invention, an icing premix composition is provided, comprising albumin, gum arabic, and confectionery sugar, wherein the icing premix composition does not include meringue, citric acid, and titanium dioxide.

In another aspect of the present invention, an icing premix composition is provided consisting essentially of albumin, gum arabic, and confectionery sugar.

In another aspect of the present invention, an icing premix composition is provided consisting of albumin, gum arabic, confectionery sugar, and food starch.

These and other features, aspects and advantages of the present invention will become better understood with reference to the following drawings, description, and claims.

### BRIEF DESCRIPTION OF THE DRAWINGS

FIG. 1 illustrates the components of a premix composition according to an embodiment of the present invention; and

FIG. 2 illustrates a method of using the composition of FIG. 1.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “confectionery sugar” refers to a refined sugar also known as confectioners' sugar, powdered sugar, 10X sugar, or icing sugar.

As used herein, the term “albumin” includes egg white, as well as derivatives of egg white and/or milk that contain the albumin protein.

The transitional phrase “consisting essentially of” limits the scope of a claim to the specified materials or steps “and those that do not materially affect the basic and novel characteristic(s)” of the claimed invention. As used herein, the phrase “consisting essentially of” excludes meringue, citric acid, and titanium dioxide and includes no more than about 10% by weight of unrecited components.

Broadly, one embodiment of the present invention is a powdered premix composition comprising albumin, gum arabic, and confectionery sugar. In some embodiments, the composition may also include a food starch, such as corn starch. The premix composition does not include meringue, citric acid, and titanium dioxide.

The inventive premix is generally used to produce royal icing for decorated desserts. Advantageously, the premix results in a more flexible royal icing which is less expensive, and which can be made in batches of varying sizes to decrease waste. Generally, the inventive premix has a shelf life of about 2 years or more.

In some embodiments, the composition comprises a weight ratio of albumin to gum arabic of between about 4 to 1 and about 5 to 1. In other words, albumin and gum arabic may be present at between about 4 parts albumin to about 1 part gum arabic and about 5 parts albumin to about 1 part gum arabic by weight.

In some embodiments, the composition comprises a weight ratio of albumin to confectionery sugar of between about 10 to 1 and about 25 to 1. In other words, albumin and confectionery sugar may be present at between about 10 parts albumin to about 1 part confectionery sugar and about 25 parts albumin and about 1 part confectionery sugar by weight.

In some embodiments, the composition comprises a weight ratio of gum arabic to confectionery sugar of between about 3 to 1 and about 6 to 1. In other words, gum arabic and confectionery sugar may be present at between 3 parts gum arabic to about 1 part confectionery sugar and about 6 parts gum arabic to about 1 part confectionery sugar by weight.

In some embodiments, albumin may be present in an amount of about 75 weight % to about 80 weight %, with the total composition being 100 weight %. In some embodiments, gum arabic may be present in an amount of about 15 weight % to about 20 weight %, with the total composition being 100 weight %.

In some embodiments, confectionery sugar may be present in an amount of about 2 weight % to about 7 weight %, with the total composition being 100 weight %.

In one embodiment, the premix may be used according to the following method. About 16 grams of the inventive premix may be blended with about 250 grams of confectionery sugar of the baker's choice. In some cases, a flavor component and/or a color component may be added. After blending, about 45 ml of water may be added and mixed with a blender at medium-low speed for about 7 minutes, or until peaks form. More water may be added for applications requiring a thinner consistency, for example glazing a cookie. The premix and confectionery sugar may be used in any order and blended, but the water is generally added last. In some cases, a small amount of edible glycerin, such as ½ tsp., may be added to produce a softer royal icing. About 10 ounces of premix may yield about 8 pounds of royal icing. The royal icing may be placed into a pastry bag, and used to create decorations for baked goods, such as cake. Such decorations may include “string work”, “piping”, “flooding”, the “glue” used to hold gingerbread house pieces together, and flavored candy “dots”, for example. Once the royal icing has been made, it may be kept covered with a damp cloth to prevent drying. Unused portions may be refrigerated for future use.

An exemplary composition comprises a blend of 13 grams of albumin, 3 grams of gum arabic, and less than 1 gram of confectionery sugar. The composition excludes meringue, citric acid, and titanium dioxide.

Referring to FIGS. 1 and 2, FIG. 1 shows the relative amounts of the components of the composition, including albumin, gum arabic, and confectionery sugar according to an embodiment of the present invention. FIG. 2 shows a method of using the composition, comprising combining the premix with confectionery sugar, adding water, blending at medium-low speed for about 7 minutes to form a royal icing, transferring the blended royal icing to a pastry bag, and decorating baked goods with the icing.

It should be understood, of course, that the foregoing relates to exemplary embodiments of the invention and that modifications may be made without departing from the spirit and scope of the invention as set forth in the following claims.

What is claimed is:

1. An icing premix composition, comprising albumin, gum arabic, and confectionery sugar, wherein the icing premix composition does not include meringue, citric acid, and titanium dioxide.

2. The icing premix composition of claim 1, further comprising a food starch.

3. The icing premix composition of claim 1, wherein albumin and gum arabic are present in a weight ratio of between about 4 parts albumin to about 1 part gum arabic and about 5 parts albumin to 1 part gum arabic.

4. The icing premix composition of claim 1, wherein albumin and confectionery sugar are present in a weight ratio of between about 10 parts albumin to about 1 part confectionery sugar and about 25 parts albumin to about 1 part confectionery sugar.

5. The icing premix composition of claim 1, wherein gum arabic and confectionery sugar are present in a weight ratio between about 3 parts gum arabic to about 1 part confectionery sugar and about 6 parts gum arabic to about 1 part confectionery sugar.

6. An icing premix composition consisting essentially of albumin, gum arabic, and confectionery sugar.

7. The icing premix composition of claim 6, wherein albumin is present in an amount of about 75 weight % to about 80 weight %, within a total composition of 100 weight %.

8. The icing premix composition of claim 6, wherein gum arabic is present in an amount of about 15 weight % to about 20 weight %, within a total composition of 100 weight %.

9. The icing premix composition of claim 6, wherein confectionery sugar is present in an amount of about 2 weight % to about 7 weight %, within a total composition of 100 weight %.

10. An icing premix composition consisting of albumin, gum arabic, confectionery sugar, and food starch.
